(19) United States
(12) Patent Application Publication
(10) Pub. No.: US 2016/0179923 A1
(43) Pub. Date: Jun. 23, 2016

(54) ADAPTIVE TRAJECTORY ANALYSIS OF REPLICATOR DYNAMICS FOR DATA CLUSTERING

(71) Applicant: Xerox Corporation, Norwalk, CT (US)

(72) Inventor: Morteza Haghir Chehreghani, Montbonnot-St-Martin (FR)

(21) Appl. No.: 14/577,472

(22) Filed: Dec. 19, 2014

(51) Int. Cl. G06F 17/30

(52) U.S. Cl. CPC G06F 17/30598; G06F 17/30575

(57) ABSTRACT

A computer-implemented method for data clustering iteratively partitions a dataset into a predetermined number of clusters. At each of a plurality of iterations, replicator dynamics is performed on the objects of newly-created clusters for a predetermined number of iterations to solve an objective function. For each of these clusters, a cut-off is computed, based on a characteristic vector of the solved objective function. One of the clusters in the current set of clusters which provides most gain to the objective function when that cluster is split into two new clusters, based on the respective cut-off, is selected. The selected one of the two clusters is split into two new clusters based on the respective cut-off and the two new clusters are added to the current set of clusters. The method thus provides for different cut-offs to be used, depending on the cluster being split.

### BACKGROUND

The exemplary embodiment relates to data clustering and finds particular application in connection with a system and method for adapting replicator dynamics through use of phase transitions to determine cuts in the data.

Clustering techniques are often used in data processing, knowledge representation and exploratory data analysis tasks such as web data analysis, image segmentation, data compression, computational biology, network analysis, computer vision, traffic management and document summarization, among others. The aim is to partition the data into a number, of clusters based on features of the individual data objects. Clustering methods often minimize a cost function which penalizes inappropriate partitions. Example clustering methods of this type include Correlation Clustering, Normalized Cut, Pairwise Clustering, and Ratio Cut. See, for example, Nikhil Bansal, et al., “Correlation clustering,” Machine Learning, pp. 238-247, 2002; Jianbo Shi, et al., “Normalized cuts and image segmentation,” IEEE Trans. Pattern Anal. Mach. Intell., 22(8):888-905 (2000), hereinafter, Shi 2000; Thomas Hofmann, et al., “Pairwise data clustering by deterministic annealing,” IEEE Trans. Pattern Anal. Mach. Intell., 19(1):1-14 (1997); and Pak K. Chan, et al., “Spectral k-way ratio-cut partitioning and clustering,” IEEE Trans. on CAD of Integrated Circuits and Systems, 13(9):1088-1096 (1994). However, minimizing such cost functions is usually NP-hard, i.e., it requires an exponential computational time unless P=NP (both the algorithm for the task runs in polynomial time and answers can be verified in polynomial time).

Several methods have been proposed to overcome the computational bottleneck. One category of methods is based on eigenvector analysis of the Laplacian matrix. Examples of such clustering methods include: i) Spectral Clustering (SC), which forms a low-dimensional embedding by the bottom eigenvectors of the Laplacian of the similarity matrix and then applies K-means to produce the final clusters (see Shi 2000; and Andrew Y. Ng, et al., “On spectral clustering: Analysis and an algorithm,” NIPS, 14, pp. 849-856 (2001)); ii) Power Iteration Clustering (PIC), which instead of embedding into a K-dimensional space, approximates an eigenvalue-weighted linear combination of all the eigenvectors of the normalized similarity matrix via early stopping of power iteration method (see Frank Lin, et al., “Power iteration clustering,” Proc. 27th Intl Conf. on Machine Learning (ICML-10), pp. 655-662 (2010)); iii) P-Spectral Clustering (PSC), which proposes a non-linear generalization of the Laplacian and then performs an iterative splitting approach based on its second eigenvector (see Thomas Bühler, et al., “Spectral clustering based on the graph p-Laplacian,” Proc. 26th Ann. Intl Conf. on Mach. Learning, ICML '09, pp. 81-88, ACM (2009); and Matthias Hein, et al., “An inverse power method for nonlinear Eigenproblems with applications in 1-spectral clustering and sparse PCA,” Adv. in Neural Information Processing Systems, 23, pp. 847-855 (2010)); and iv) Dominant Set Clustering (DSC), an iterative method which at each iteration, peels off a cluster by performing a replicator dynamics until its convergence (see, Massimiliano Pavan et al., “Dominant sets and pairwise clustering,” IEEE Trans. Pattern Anal. Mach. Intell., 29(1):167-172 (2007), hereinafter, Pavan 2007; Bernard Ng, et al., “Group replicator dynamics: A novel group-wise evolutionary approach for sparse brain network detection,” IEEE Trans. Med. Imaging, 31(3):576-585 (2012), hereinafter, Ng 2012; and Hairong Liu, et al., “Fast detection of dense subgraphs with iterative shrinking and expansion,” IEEE Trans. Pattern Anal. Mach. Intell., 35(9):2131-2142 (2013), hereinafter, Liu 2013).

Replicator dynamics is a useful tool, however, the method has several problems, such as the difficulty in defining parameters and the need to reach convergence, which can entail; a large number of iterations.

### BRIEF DESCRIPTION

In accordance with one aspect of the exemplary embodiment, a method for data clustering includes, for a dataset of objects partitioned into a current set comprising two clusters, iteratively increasing a number of the clusters in the current set of clusters. This includes performing replicator dynamics on the objects in each of the two clusters for a predetermined number of iterations to solve an objective function. For each of the clusters, a cut-off is computed, based on a characteristic vector of the solved objective function. One of the clusters in the current set of clusters which provides most gain to the objective function, when that cluster is split into two new clusters at the respective cut-off, is selected. The selected one of the two clusters is split into two new clusters based on the cut-off and the two new clusters are added to the current set of clusters. In a next iteration, the replicator dynamics is performed on the two new clusters.

One or more of the steps of the method may be performed with a processor.

In accordance with another aspect of the exemplary embodiment, a system for clustering objects is provided. The system includes a similarity matrix computation component which computes pairwise similarities for a dataset of objects and for clusters generated from the dataset and which generates a pairwise similarity matrix based on the pairwise similarities. A replicator dynamics component performs replicator dynamics on the dataset of objects, and on clusters generated from the dataset, to solve an objective function which is a function of the pairwise similarity matrix. A cut-off computation component computes a cut-off based on a characteristic vector of the solved objective function. A gain computation component computes a gain in the objective function when each of the clusters is split into two new clusters at the computed cut-off for that cluster and identifies a cluster to be split which provides most gain to an objective function when that cluster is split into the two new clusters. A pruning component which prunes the clusters when a desired number of clusters is reached. A processor implements the similarity matrix computation component, replicator dynamics component, cut-off computation component, gain computation component, and pruning component to iteratively increase the number of the clusters.

In accordance with another aspect of the exemplary embodiment, a method for data clustering includes partitioning a dataset of objects into clusters, the partitioning including, with a processor, performing replicator dynamics on the objects the dataset of objects for a predetermined number of iterations to solve an objective function. A cut-off is computed, based on a characteristic vector of the solved objective function. The dataset is split into two clusters based on the cut-off to form a current set of clusters. A gain achieved by splitting each of the clusters in the current set of clusters into two new clusters, when the previous steps are performed for each of the clusters, is computed. The cluster with the maximum gain is split into two new clusters and the two new clusters are added to the current set of clusters. The previous two steps are repeated for a number of iterations until a predetermined number of clusters is reached.

### BRIEF DESCRIPTION OF THE DRAWINGS

FIG. 1 illustrates a system for clustering data objects in accordance with a first aspect of the exemplary embodiment;

FIG. 2 illustrates a method for clustering data objects in accordance with a second aspect of the exemplary embodiment;

FIGS. 3-6 show Dominant Set Clustering (DSC) clustering solutions for different numbers of updates: T=10, T=50, T=125, and T=130, respectively;

FIGS. 7-10 show trajectory analysis of replicator dynamics for different numbers of updates: T=10, 50, 125, and 130, respectively;

FIG. 11 illustrates cut identification in the exemplary method;

FIG. 12 illustrates cluster pruning in the exemplary method;

FIG. 13 illustrates a toy example in which each pair of data objects in the similarity matrix has one of two similarity scores, except for the diagonal pairs;

FIGS. 14-16 show the results of regularized replicator dynamics on the data of FIG. 13 for different numbers of updates: T=1, 10, and 40, respectively;

FIG. 17 shows the matrix of pairwise similarities for the entire dataset used in FIG. 3;

FIG. 18 shows the matrix of pairwise similarities for the second half of the dataset of FIG. 3;

FIG. 19 shows results of a combination of a path-based distance measure with Replicator Dynamics Clustering (RDC) to cluster data with arbitrary clusters;

FIG. 20 shows results of a combination of a path-based distance measure with Replicator Dynamics Clustering (RDC) to cluster another set of data with arbitrary clusters;

FIG. 21 illustrates an example dataset in which one cluster is far away from two other clusters; and

FIG. 22 is a power iteration vector for the dataset of FIG. 21, showing that power iteration clustering (PIC) is not able to distinguish the finer resolution.

### DETAILED DESCRIPTION

The exemplary embodiment relates to a system and method in which replicator dynamics is employed for extracting clusters from the data and structure identification. Replicator dynamics, like power iteration clustering, computes a one-dimensional embedding of data. However, the exemplary replicator dynamics method can separate the significant structure from the noise and outliers. The exemplary method analyses the trajectory of replicator dynamics to identify phase transitions which are used to select cut offs for establishing cuts over the data. A cut is used to separate some clusters from the other clusters or from noise. An exemplary clustering method includes detecting phase transitions, identifies the main cuts, and then pruning the resulting clusters. In some aspects, a regularized variant of replicator dynamics is employed, which accelerates the occurrence of phase transitions, which leads to an adaptive replicator dynamics.

Detecting occurrence of phase transitions is significantly faster than running replicator dynamics until convergence. Experiments on synthetic and real-world datasets show the effectiveness of the method and provide comparisons with other clustering techniques.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

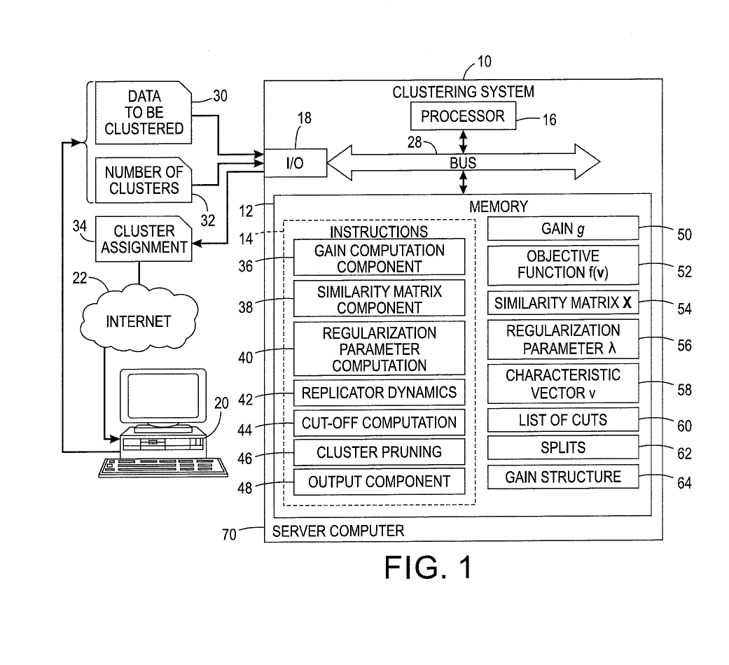

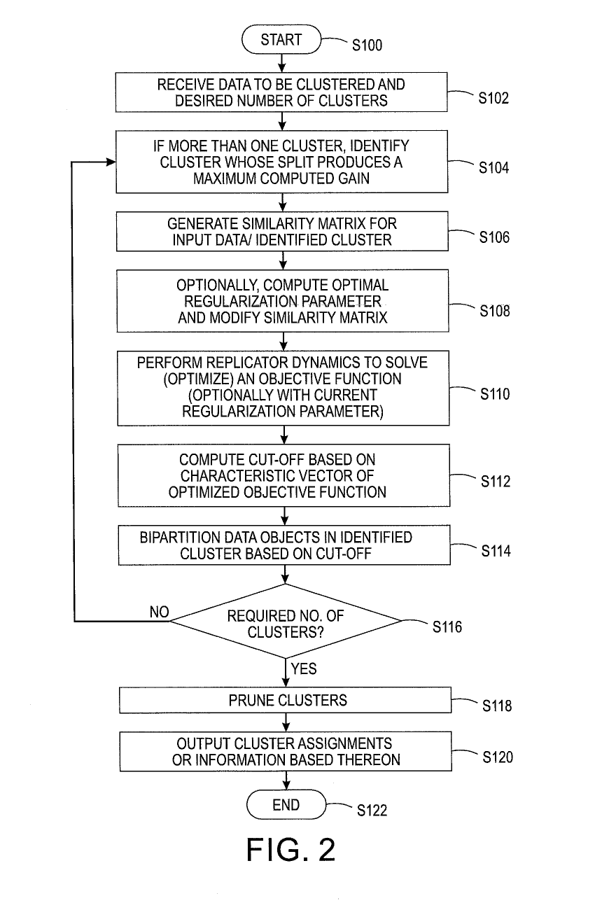

FIG. 1 illustrates a computer-implemented system 10 for data clustering using replicator dynamics. The system includes non-transitory memory 12 which stores instructions 14 for performing the method illustrated in FIG. 2 and a processor 16 in communication with the memory for executing the instructions. The system 10 also includes one or more input/output (I/O) devices, such as a network interface 18 for communicating with external devices, such as the illustrated client computing device 20, which is communicatively connected to the system by a wired or wireless link 22, such as a local area network or a wide area network, such as the Internet. The various hardware components 12, 16, 18 of the system 10 may be all connected by a data/control bus 24. While the system is illustrated in terms of a server and client it is to be appreciated that other configurations are contemplated which include one two, or more computing devices.

The system receives as input data 30 to be clustered, which may be stored in memory 12 during clustering. The data includes a set of data objects which can each be suitably represented by a multidimensional vector in a D-dimensional space, such as text documents, images, scientific data, and the like. D can be at least 2, and is generally at least 5 or at least 10, or at least 30, and in some embodiments is up to 1000, or more. For example, text documents may be represented by their term frequency-inverse document frequency (tf-idf), which is a measure of word frequency for a set of words, or other representation based on words of the document (see, e.g., US Pub. No. 20130204885, by Stephane Clinchant, et al.). Images can be represented by a statistical representation of pixels of the image, such as one which assumes an underlying generative model, as in the case of the Fisher vector or bag-of words representation (see, e.g., U.S. Pub. No. 20120045134, by Florent Perronnin, et al. and U.S. Pub. No. 20080069456, by Florent Perronnin). A desired number of clusters 32, such as three, four, five or more clusters, may also be received or a default value selected. The system outputs the cluster assignments 34 of the data 30, in which each data object in the data is assigned to no more than one of the clusters (i.e., to 0 or 1 of the clusters).

The instructions include a gain computation component 36, a similarity matrix component 38, a regularization parameter computation component 40 (optional), a replicator dynamics component 42, a cut-off computation component 44, an optional cluster pruning component 46, and an output component 48. These components are best understood with respect to the method described below.

Briefly, the gain computation component 36 computes a gain 50 to an objective function 52 for each of a current set of clusters so that the cluster producing the most gain when split at a respective cut-off can be identified as the next one to be split. Initially, there is only one cluster-the entire dataset, so no gain need be computed for the dataset.

The similarity matrix component 38 initially generates a matrix 54 of pairwise similarities for the data objects in the data 30 and, subsequently, for the data objects in a cluster, based on their vectorial representations. The regularization parameter computation component 40 optionally computes a regularization parameter 56, based on the current similarity matrix 54 and may use this to modify the similarity matrix 54 to speed up replicator dynamics.

The replicator dynamics component 42 performs replicator dynamics on the data objects (in the initial data or in a cluster generated therefrom), which includes computing a characteristic vector 58 in which each index i of the vector corresponds to one of the data objects in the data set/cluster, the vector being one which optimizes the objective function 52 over a number of iterations. The cut-off computation component 44 computes a cut-off (threshold) based on the values of the characteristic vector 58 optimizing the objective function. The cut-off is used to bipartition (cut) the data objects represented in the characteristic vector 58 to form two (temporary) clusters. A Cut refers to separating some clusters from the other clusters or from noise. The corresponding data objects in the cluster are removed from the similarity matrix 54.

When the desired number of clusters is reached, the cluster pruning component 46 prunes the resulting clusters to remove likely outliers. The output component 48 outputs the resulting cluster assignments of the data objects 34, or information generated based on the cluster assignments.

The system 10 may make use of several data structures for efficient optimization of the objective function 52, including a list of cuts 60, a list of splits (Splits) 62, and a gain structure 64, which stores the amount of gain 50 in the objective function 52.

The computer system 10 may include one or more computing devices 70, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 18 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 70.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

With reference to FIG. 2, a method for clustering data objects is shown which may be performed by the system of FIG. 1. The method begins at S100.

At S102, data 30 to be clustered and a desired number 32 of clusters are input to the system 10 and may be stored in memory 12.

At S104, if there is more than one cluster, the cluster generating a maximum gain 50 is identified (by the gain computation component) by computing a gain function. Initially, there is only one cluster-the entire dataset, so this step is omitted then.

At S106, a similarity matrix 54 is generated based on the input data objects 30 (or the data objects in only the identified cluster). For each pair of data objects, the similarity matrix 54 includes a pairwise similarity between their representations. The pairwise similarities can be derived from pairwise distances between the representations of the data objects. The distances can be computed using any suitable distance measure, such as the (squared) Euclidean distance, Hamming distance, or the like.

At S108, in some embodiments, a regularization parameter 56 may be computed (by the regularization parameter computation component 40), based on the (current) similarity matrix 54. The similarity matrix may be modified based on the regularization parameter. This helps to speed up the replicator dynamics, but may be omitted.

At S110, replicator dynamics is performed (by the replicator dynamics component 42) using the current similarity matrix 54 (and, optionally, the current regularization parameter) to obtain a characteristic vector 48 which optimizes, over a fixed number of iterations, an objective function 50 that is a function of a characteristic vector 58, the similarity matrix 54 (and optionally, current regularization parameter).

At S112, a cut-off is computed (by the cut-off computation component 44) based on the values in the characteristic vector 58 (this is described in further detail with respect to Algorithm 1).

At S114, the data objects represented in the current matrix 54 are bi-partitioned, based on the cut-off computed at S112, into two subsets (candidate splits) and their respective index value in the updated characteristic vector.

If at S116, the desired number of clusters has not been reached, the method returns to S104 for the next iteration, otherwise proceeds to S118, where the clusters may be pruned to remove likely outliers.

At S120, the cluster assignments, or information based thereon, is/are output. The method ends at S122.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 70, (for example, an internal hard drive of RAM), or may be separate (for example, an external hard drive operatively connected with the computer 70), or may be separate and accessed via a digital data network such as a local area network (LAN) or the Internet (for example, as a redundant array of inexpensive of independent disks (RAID) or other network server storage that is indirectly accessed by the computer 70, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

### 1. NOTATIONS AND DEFINITIONS

For a set of N data objects, relations between the objects can be represented in different ways, e.g., as vectors or pairwise similarities. In the following, the relations between the objects are given by the matrix of pairwise similarities 54, denoted X. The input data 30 can be represented by a graph [symbol] (O,X), with the set of N nodes (objects) O and the N×N symmetric and non-negative similarity matrix X, where objects are ordered by decreasing similarity, in two dimensions. It may be noted that the vector representation can be considered as a special case of graph representation, where the pairwise measurements are computed, for example, by squared Euclidean distances (see, Volker Roth, et al., “Optimal cluster preserving embedding of nonmetric proximity data,” IEEE Trans. Pattern Analysis and Machine Intelligence, 25(12), pp. 1540-1551 (2003)). The goal is to partition the graph into clusters, i.e., into groups of similar objects which are distinguishable from the objects of other groups. A clustering solution is denoted by c, where cᵢ indicates the label for object i.

The pairwise similarities and distances can be converted to each other via negation and shift transformations. For example, given pairwise distances D, the similarity matrix X is obtained by X=max(D)−D+min(D). max(D) is the maximum distance in the matrix of pairwise distances. min(D) is the minimum distance (other than 0, where an object is compared with itself) in the matrix of pairwise distances. Similarly, given pairwise similarities X, the distance matrix D is obtained by D=max(X)−X+min(X). This particular transformation, i) is nonparametric, ii) provides a unique range for both X and D, and iii) is reversible, i.e., converting X (or D) to D (or X) and then again to X (or D) gives the original matrix.

### 2. ADAPTIVE TRAIECTORY ANALYSIS OF REPLICATOR DYNAMICS

A dense (well-connected) part of a graph [symbol] (O,X) can be obtained by solving the following objective function 52 for a quadratic programming problem:

maximize ƒ(v)=v^{T}Xv, subject to v≧0, Σᵢ₌₁^{N}νᵢ=1 (1),

where v is the N-dimensional characteristic vector 58 which determines the participation of the objects in the dense region (cluster). T represents the transpose of the respective vector. The exemplary method uses replicator dynamics to solve Eqn (1) (S110). This class of discrete time dynamic systems has been used in the context of evolutionary game theory (see, e.g., P. Schuster, et al., “Replicator dynamics,” J. Theor. Biol., 100:533-538 (1983); J. W. Weibull, “Evolutionary game theory,” MIT Press, Cambridge, Mass. (1997)). The replicator dynamics equation is defined as:

$${v}_{i} ( t + 1 ) = {v}_{i} ( t ) \frac{{( Xv ( t ) )}_{i}}{{v ( t )}^{T} Xv ( t )} , i = 1 , … , N , t = 1 , … , T , \qquad ( 2 )$$

where t represents one of T iterations and t+1 represents a next iteration after t.

The stable solutions of the replicator dynamics equation shown in Eqn (2) have been shown by Weibull to be in one-to-one correspondence to the solutions of the objective function of Eqn (1), which is always non-decreasing as the replicator equation is updated. However, the matrix X should satisfy two conditions: I) its diagonal elements are all zero, and II) its off-diagonal elements are all non-negative and symmetric. To comply with I), the similarity between an object and itself is set to 0 in the matrix.

For a large enough T, v converges to the cluster that corresponds to the densest part (the dominant mode) of the graph.

The existing clustering methods based on replicator dynamics (e.g., DSC (Pavan 2007; Ng 2012; Liu 2013)) perform a sequential peeling-off strategy where at each step, i) a replicator dynamics is first performed on the available graph, and ii) a new cluster is then constructed by separating the nodes whose characteristic values are higher than a cut off parameter, denoted cut_off. This type of algorithm thus requires two parameters to be fixed in advance: i) the cut_off and ii) the number of update iterations of replicator dynamics, denoted by T. DSC suggests that the cut_off be fixed with the epsilon of the programming language used for implementation, e.g., 2.2204e−16. Conventional DSC performs the replicator dynamics until it converges to a stable solution, i.e., T is set to a large number. However, this approach has several deficiencies:

1. Setting appropriate values for T and the cut_off is not straightforward and may require prior knowledge about the underlying structure.

2. The convergence of replicator dynamics can be slow, i.e., it may require an exponential number of iterations (with respect to the input size) to converge. In particular, for asymmetric structures, the replicator dynamics quickly separates the far away clusters, but then only very slowly discriminates the closer structures.

3. DSC may split a perfect cluster in two, due to, for example, choosing an inappropriate T or cut_off.

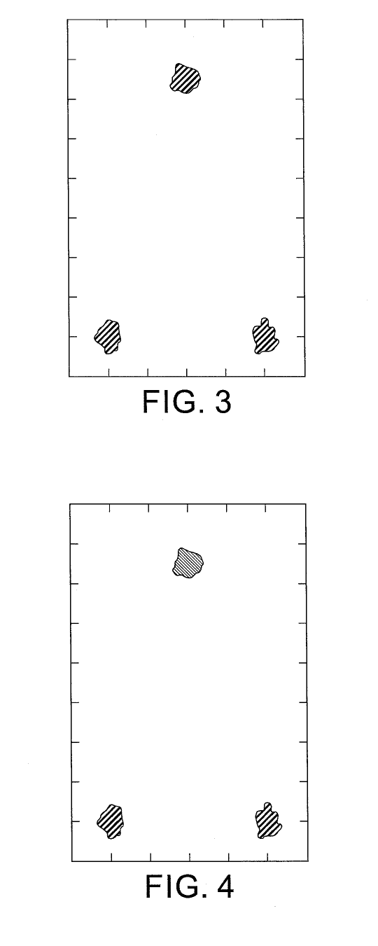

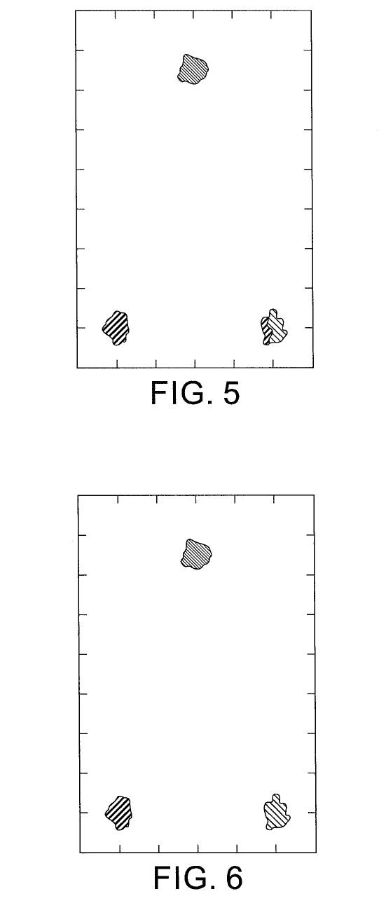

By way of example, DSC clustering solutions for different numbers of updates of the replicator dynamics equation (Eqn (2)) are shown in FIGS. 3-6 (where the clusters have been enlarged for clarity). These plots illustrate that DSC may require a large number of iterations even for a rather simple dataset to compute appropriate clusters. To obtain these plots, the pairwise similarities are computed by Xᵢⱼ=max(D)−Dᵢⱼ+min(D), where D is the matrix of pairwise squared Euclidean distances. It can be seen that the DSC method requires a rather large number of iterations to separate the clusters perfectly (the smallest T to achieve this reliably is 130, as shown in FIG. 6). When stopping earlier, either the close clusters are grouped together (e.g., for T=50 in FIG. 4), or an inappropriate cut is performed (for T=125 in FIG. 5). A similar situation holds for the cut_off threshold, i.e., finding an optimal (and a priori fixed) threshold to separate exactly the most dominant cluster can be very challenging. Additionally, this procedure is rather slow and computationally expensive.

In the exemplary clustering method, it is not necessary to fix the cut_off in advance. Additionally, the objective function of Eqn. (1) can be replaced with one which includes a regularization term which incorporates the regularization parameter 54, denoted A. Further, T need not be set to a large number.

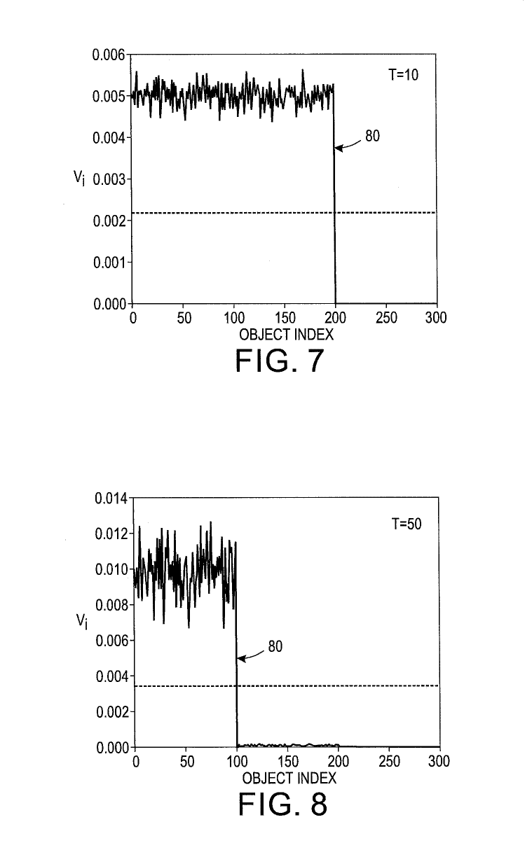

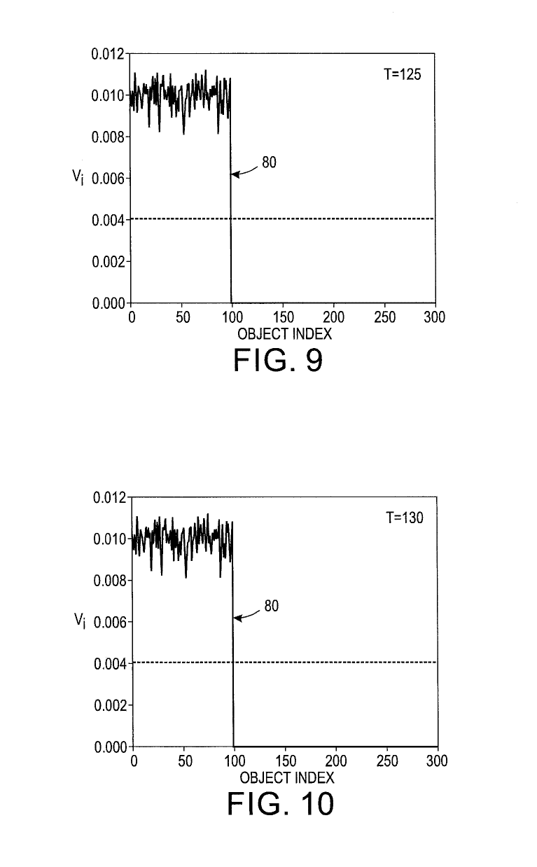

One source of information which is not used by DSC is the trajectory of replicator dynamics, i.e., the characteristic vector v. This reveals in formative phase transitions. FIGS. 7-10 show trajectory analysis of replicator dynamics on the data used in FIGS. 3-6, showing the values ν₁ of the object indices of the characteristic vector v for different number of updates (T=10, 50, 125, 130).

It can be seen from these example graphs that even after only few updates, e.g. T=10, an informative phase transition occurs, which represents a cut, i.e., the separation of a subset of data (the cluster at the top in FIGS. 3-6) from the rest of dataset. The separation occurs between the clusters, i.e., some clusters (closer to the mode) are separated from the other clusters or from the noise. However, this number of iterations is not yet large enough to specify convergence to a single cluster precisely. Therefore, this information cannot be used by the standard DSC algorithm as it waits until the replicator dynamics converges to the most dominant cluster (the earliest occurrence happens at T=130). This analysis, however, provides useful insights on the performance of replicator dynamics: i) during running a replicator dynamics, several phase transitions may occur which provide useful information; ii) the appearance of a phase transition is much cheaper (faster) than separating a single cluster and thus waiting until the convergence of the replicator dynamics; and iii) a phase transition represents a cut (split) over the dataset and between the clusters. Such inferences are used in the exemplary method, referred to herein as Replicator Dynamics Clustering (RDC), for designing an efficient clustering algorithm.

### 3. EFFICIENT DETECTION OF PHASE TRANSITIONS (S112)

The exemplary RDC clustering method relies on detecting the strongest transition 80 (e.g., see FIGS. 7-10) on replicator dynamics which identifies a cut over the dataset after the predetermined number of iterations of replicator dynamics have been performed (at S110). To compute the sharpest phase transition 80, one approach includes preparing a sorted copy of v, e.g., sorting v by increasing value of νᵢ, computing the difference between each consecutive pair of sorted elements, and then choosing the maximal difference (gap), which represents the maximal transition. Then, the middle of this gap gives the most distinguishing cut_off. Sorting the N elements of v requires [symbol] (N log N) running time.

However, for computing the most dominant transition, it is not necessary to sort the whole vector, since identifying the exact positions of many items is not relevant. A more efficient algorithm for computing the cut off which is linear in N can thus be employed, as shown below in Algorithm 1.

| Algorithm 1 compute_cut_off (v) | |
|---|---|
| Require: characteristic vector v. | |
| 1: | Compute min(v) and max(v). |
| 2: | Construct N − 1 blocks by dividing the interval |
| | [min(v), max(v)] by N − 1, where the size of each block is |
| | $h = \frac{max ( v ) - min ( v )}{N - 1} .$ |
| 3: | for 1 ≦ i ≦ N, vᵢ ∉ {max(v), min(v)} do |
| 4: | $b [ i ] = ⌊ \frac{( {v}_{i} - min ( v ) )}{h} ⌋$ |
| 5: | end for |
| 6: | or all bₖ do |
| 7: | Compute min(bₖ) and max(bₖ) |
| 8: | end for |
| 9: | Create ordered list L containing the minima and |
| | maxima of the blocks |
| | L = {min(v), min(b₁), max(b₁), . . . , min(bₖ), max(bₖ), . . . , |
| | min(b_{N -1}), max(b_{N -1}), max(v)}. |
| 10: | for 1 ≦ i < length (L) do |
| 11: | diff [i] = L+[i + 1] − L[i] |
| 13: | end for |
| 12: | ind = argmax diff [i] |
| 13: | $cut\_off = \frac{L [ ind ] + L [ ind + 1 \}}{2}$ |
| 14: | return cut_off |

In the exemplary method, Algorithm 1 takes as input the computed v which optimizes the objective function that is output at S110. At step 1 of Algorithm 1, the minimum and maximum values in v are identified where min(v) is the smallest ν₁ in v and max(v) is the largest.

At step 2, blocks are constructed. The interval [min(v), max(v)] is partitioned into N−1 equal-size blocks, where the size of each block is h=(max(v)−min(v))/(N−1), N being the number of indices in v.

At steps 3-5, the objects are assigned to the blocks, such that the block of object i is determined by

$$b [ i ] = ⌊ \frac{( {v}_{i} - min ( v ) )}{h} ⌋ .$$

At steps 6-8, for each block, the maximum and minimum values min(bₖ) and max(bₖ) in the block are identified.

At step 9, an ordered list L is constructed by concatenating the minima and the maxima of the blocks, in order, i.e.,

L={min(v),min(b₁),max(b₁), . . . ,min(bₖ),max(bₖ), . . . ,min(b_{N-1}),max(b_{N-1}),max(v)}. (3)

L is sorted in increasing order, i.e., min(b₁), max(b₁)<min(b₂), max(b₂), etc., starting with min(v) and ending with max(v).

At steps 10-12, the difference between each consecutive pair in the ordered list L is computed to obtain the position of the maximal transition (maximum pair difference) at step 13. The midpoint of this transition (or gap) is identified as the cut_off, which computed as shown in step 14 (assumed to be halfway between the consecutive blocks at which the maximum gap is found). In partitioning the data objects into two (S114), the objects with an object index below the cut_off are assigned to one Split and those above the cut_off are assigned to the Split.

Lemma 1 guarantees the correctness of Algorithm 1.

Lemma 1

Algorithm 1 computes the sharpest transition on a given vector v.

Proof:

The correctness of Algorithm 1 can be proven via the Pigeonhole principle: after picking out min(v) and max(v), N−1 blocks are constructed, but there are at most N−2 elements left from v. Therefore, according to the Pigeonhole principle, at least one block is left empty. This implies that the largest gap is at least h, the size of blocks. Therefore, the largest gap cannot happen inside a block. Thus, it is only necessary to consider the difference of max(bₖ₋₁) and min(bₖ) and ignore the other elements of the blocks. □

Computational Complexity:

Assigning the elements to blocks as well as computing the block-wise min and max operations are linear, therefore the total computational complexity of Algorithm 1 is [symbol] (N) instead of [symbol] (N log N).

As will be appreciated, other methods for identifying the cut_off from v are contemplated.

### 4. REPLICATOR DYNAMICS CLUSTERING (RDC)

The analysis of the trajectory of replicator dynamics yields an efficient iterative clustering algorithm (see Algorithm 2). Replicator dynamics, very quickly, reveals a phase transition, which corresponds to a cut over the data. The exemplary algorithm uses three main data structures:

1. List_of_Cuts: The List_of_Cuts data structure 60 keeps the list of (potential) clusters. Essentially, it is a list of sublists, where each sublist List_of_Cuts[k] represents a subset of the data containing a cluster or a collection of clusters.

2. Splits: The Splits data structure 62 is a list of sublists where each sublist Splits[k] contains the bi-partitioning (i.e., a cut) of the subset stored in List_of_Cuts[k] via performing a replicator dynamics.

3. gain: The gain data structure 64 stores the improvement in the objective function ƒ(v) if List_of_Cuts[k] is split into two subsets (clusters) Splits[k][1] and Splits[k][2].

The exemplary clustering method is performed in two stages: i) Cut Identification, and ii) Cluster Pruning. The cluster pruning stage provides automatic separation of structure from noise and outliers.

A. Cut Identification

In the first stage (S104-S116), the data graph is partitioned by performing cuts via replicator dynamics. The cuts are computed in a top-down manner. At the beginning, the data includes no cut. Then, iteratively, the most significant cut is selected and performed at each step. The procedure continues for no_of_clusters−1 cuts, such that at the end, there will be no_of_clusters subsets of original data (S116). The significance of a cut is determined by the amount of gain 50 from the cut, i.e., how much the objective function ƒ(v) 52 increases if the cut is performed. For this purpose, the impact of performing a replicator dynamics on each sublist in the List_of_Cuts 60 is evaluated. The gain g of splitting the kth sublist (cluster) is computed as the difference between the objective function of the completed replicator dynamics (after T updates) and the objective function of uniform v, i.e.,

gₖ=ƒ(v(T))−ƒ(v(t₀)). (4)

In Eqn (4), ƒ(v(t₀)) represents a uniform distribution obtained by:

$$f ( v ( {t}_{0} ) ) = \frac{1}{dim ( X )} {e}^{T} X \frac{1}{dim ( X )} e = \frac{sum ( X )}{size ( X )} . \qquad ( 5 ) ,$$

where e is a vector of 1 s, and sum(X) and size(X) respectively indicate the sum and the number of elements of X. The splits of the current subsets of data are ranked according to their gₖ's and the one yielding the maximal gain is chosen (at S104) as the one to be split. Then, the respective list is popped out from List_of_Cuts (i.e., List_of_Cuts[maxInd]) and its sub-lists (the new potential clusters) stored in Splits[maxInd][1] and Splits[maxInd][2]. The other data structures are also updated, i.e., replicator dynamics are performed on Splits[maxInd][1] and Splits[maxInd][2] and then Splits[maxInd] is replaced by the resultant splits. The gain structure is also updated accordingly. Algorithm 2 describes the procedure in detail.

Algorithm 2 Cut Identification step
Require X, no_of_clusters, T

| | |
|---|---|
| 1: | curK = 1 |
| 2: | gain, Splits = [ ] |
| 3: | List_of_Cuts.append([1,..,N]) |
| 4: | v, obj_new = run_replic_dynamics(X,T) |
| 5: | obj_old = sum(X)/size(X) |
| 6: | gain.append(obj_new − obj_old) |
| 7. | cut_off = compute_cut_off(v) |
| 8: | tmpSplit[1] = where (v ≧ cut_off) |
| 9: | tmpSplit[2] = where (v < cut_off) |
| 10: | Splits.append(tmpSplit) |
| 11: | while curK < no_of_clusters |

| | |
|---|---|
| 12: | maxInd = argmaxₖgain |
| 13: | cur_nodes = List_of_Cuts[maxInd] |
| 14: | List_of_Cuts.remove_at(maxInd) |
| 15: | bestSplit = Splits[maxInd] |
| 16: | Splits.remove_at(maxInd) |
| 17: | gain.remove_at(maxInd) |

| | |
|---|---|
| 18: | for curSplit in bestSplit do |
| 19: | List_of_Cuts.append(curSplit) |
| 20: | X^{tmp} = X[curSplit,curSplit] |
| 21: | v,obj_new = run_replic_dynamics(X^{tmp},T) |
| 22: | obj_old = sum(X^{tmp})/size(X^{tmp}) |
| 23: | gain.append(obj_new − obj_old) |
| 24: | cut_off = compute_cut_off(v) |
| 25: | tmpSplit[1] = curSplit[where(v ≧ cut_off)] |
| 26: | tmpSplit[2] = curSplit[where(v < cut_off)] |
| 27: | Splits.append(tmpSplit) |

| | |
|---|---|
| 28: | end for |
| 29: | curK = curK + 1 |

| | |
|---|---|
| 30: | end while |
| 31: | return List_of_Cuts,Splits |

Briefly, Algorithm 2 takes as input the number of clusters no_of_clusters to be formed, the matrix X (computed at S104 or S108) and the number T of iterations to be performed each time replicator dynamics is used.

Steps 1-10 constitute initialization steps of the algorithm.

At step 1, the current number curK of clusters generated is initially set to 1 (representing the entire dataset). v is initialized, e.g., by setting the values of all the object indices to 1/N. At step 2, the gain and splits data structures are initialized (initially these are empty).

At step 3, in the List_of_Cuts, there are initially no cuts. Thus, there is initially only one sublist in List_of_Cuts with all the data placed in that.

At step 4, replicator dynamics is run on the initial set of data for T iterations, each time updating v. The output of this step is a new v and a new objective function ƒ(v(T)) (corresponding to S110).

At step 5, the old objective function ƒ(v(t₀)) is computed according to Eqn (5).

At step 6, the gain in the objective function obtained by performing a cut of the entire dataset, based on the new v, is computed according to Eqn (4) and stored in the gain data structure (corresponding to S104).

At step 7, the cut_off corresponding to the maximum difference between any two values in the vector v is computed, e.g., using Algorithm 1, based on the computed v at iteration T (corresponding to S112).

At steps 8 and 9, a temporary split is created for the object indices whose values in v meet or exceed the cut_off and for the object indices whose values in v are less than the cut_off, respectively (corresponding to S114). At step 10, the temporary splits generated at lines 8 and 9 are added to the Splits data structure. There is thus a one to one mapping between the List_of_Cuts and the List of Splits, i.e., Splits[k] shows a bi-partitioning or split of the data in List_of_Cuts[k].

Steps 4-10 thus result in a bi-partitioning of the entire dataset into two clusters. These splits (clusters) are considered as temporary splits (clusters), since in the following steps, one or both of these clusters may be eventually split into two or more clusters.

At step 11, while the current number of clusters is less than the desired number of clusters, the loop including steps 12-29 are performed. At each iteration of these steps, only one of the current set of clusters is split into two clusters, which is the one providing the maximum gain in the current objective function.

At step 12, the split providing the maximum gain is identified from the gain structure (corresponding to S104). Initially there is only one split, so in the first iteration, this is the one providing the maximum gain.

At step 13, the current set of nodes (objects) is obtained from a sublist in List_of_Cuts whose respective gain is maximal, i.e. the cluster to be split further. At step 14, the List_of_Cuts is updated to remove this origin cluster. At step 15, the bestSplit is updated to correspond to the subset (cluster) being split further. At step 16, the sublist corresponding to the maximal gain is removed from the list of splits. At step 17, the maximal gain is removed from the gain vector.

At step 18, in the inner loop, for the temporary cluster in best split (stored in the bestSplit), steps 18-27 are performed, which includes adding each of the temporary clusters to the list of main clusters List_of_Cuts, then performing replicator dynamics on each of them (corresponding to S110) and identifying the new cut_off for each using Algorithm 1 (corresponding to S112). These steps are essentially a repeat of steps 3-10, but add step 20, where X^{tmp}, which is used in the computing of the old objective function at step 22, is set as the similarity matrix of the cluster being split (S106). This loop ends at step 28 and at step 29, the current K is incremented by 1. The method returns to step 12 for the next iteration where the splits produced in the last iteration are evaluated to determine which one gives the maximum gain, and increasing the number of clusters by one. At step 30, when K is equal to the required number of clusters, the while loop ends.

At step 31, the algorithm outputs the List_of_{Cuts} and the corresponding Splits, identifying the data objects in each cluster.

As an example, starting with one cluster (the entire dataset) at step 1, the method runs replicator dynamics on this cluster, computes a cut-off with Algorithm 1, producing two temporary clusters stored in Splits[1]. In the while loop, these two temporary clusters are added to the list of main clusters (to List_of_Cuts) replacing their origin cluster. Also, replicator dynamics is performed on these two new clusters and a cut-off determined, then in the next iteration at step 12, the cluster which produces the most gain by splitting is identified and only that one is split and again the splits replace the cluster. Given the three clusters, replicator dynamics need only be performed on the new clusters produced from the split, since the gain for the remaining cluster which was not split has already been computed. At each iteration, therefore, a new cut is performed and the members of the clusters generated are added to the splits, while the cluster from which they were generated is removed. Thus, at each iteration, the number of clusters increases by one, until the desired number of clusters is achieved. The method then proceeds to the cluster pruning stage.

B. Cluster Pruning (S118)

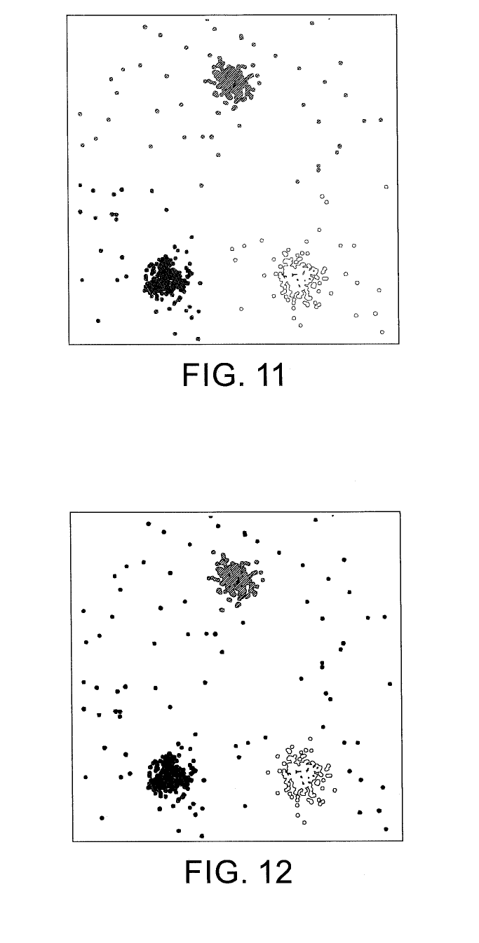

So far, the method has identified the main cuts over the dataset. However, the cuts may be contaminated by outliers and noise. An example is depicted in FIGS. 11-12, where FIG. 11 shows the cuts performed by Algorithm 2. Therefore, in step S118, the clusters are pruned to separate the structure from noise. In Algorithm 2, the lists stored in Splits contain the bi-partitioning of the subsets (clusters) in List_of_Cuts. Whenever there is only one cluster in List_of_Cuts[k], the bi-partitioning of this cluster then separates the well-connected part (i.e., the structure) from the rest (i.e., the noise). Thus, for the cluster pruning, Split[k][1] is kept and Split[k][2] is reported as noise.

For each of the clusters, in the desired number of clusters, the pruning thus includes performing replicator dynamics on the objects in the cluster for a predetermined number of iterations to solve the objective function, computing a cut-off based on a characteristic vector of the solved objective function, and removing the objects below the cut-off from the cluster.

FIG. 12 shows the results of applying this pruning step. Note that methods like K-means or spectral methods produce results similar to FIG. 11, i.e., they do not separate structure from the noise.

Adaptive Replicator Dynamics Clustering

Replicator dynamics can converge fairly slowly, particularly when the structure is nested. Although the formation of a phase transition occurs faster than convergence of the conventional replicator dynamics to its stable solution, the occurrence of a phase transition can still be accelerated. In one embodiment, a regularized version of the replicator dynamics is employed (Adaptive Replicator Dynamics Clustering), which yields a faster occurrence of phase transition and convergence to a stable solution.

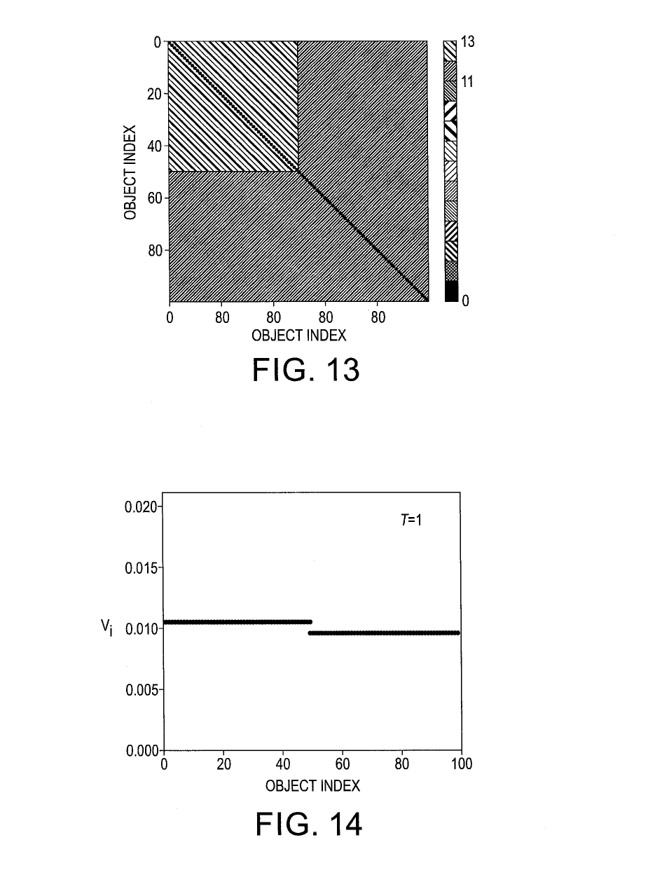

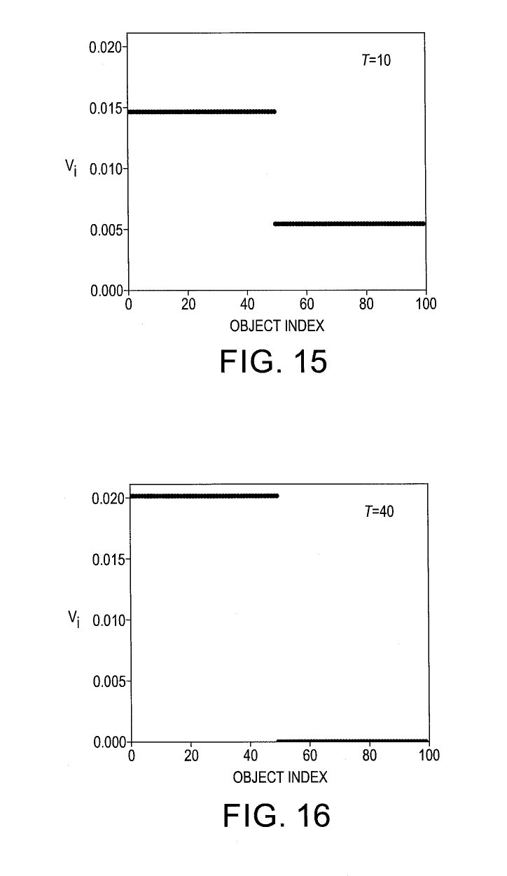

In particular, it is observed that when the data contains nested structures, then, i) the convergence to the deepest structure can be slow, and ii) the phase transition separating the nested structure from the rest of data may occur only after a large T. A toy example is depicted in FIGS. 13-16, where the pairwise similarities of the interior structure are fixed at 13 and the other similarities are 11 (FIG. 13). The convergence of the replicator dynamics is rather slow, i.e., it takes T=40 update steps to reach an optimal stable v, as shown in FIG. 16. At the intermediate steps, i.e. T=1 (FIG. 14) or T=10 (FIG. 15), the phase transition might not be strong enough yet to indicate a cut.

Essentially, a phase transition occurs whenever a subset of objects contributes more than the others to the characteristic vector, i.e. their νᵢ's are significantly larger. Therefore, in order to accelerate the appearance of phase transitions, a regularization term λ∥v∥₂² may be added to the objective function, to force a tighter distribution over v. Thus ƒ in Eq. 1 can be replaced by ƒ^{reg} defined as:

$${f}^{reg} ( v , λ ) = {v}^{T} {X}^{′} v + λ {‖ v ‖}_{2}^{2} . \qquad ( 6 )$$

where λ denotes the regularization parameter 56, X′ is a similarity matrix derived from X (which can be different from or equal to X) and ∥v∥₂² is the squared norm of v (or can be another scalar parameter which is a function of v). This special choice of regularization provides a closed-form way to solve the new objective function via replicator dynamics.

Lemma 2:

The solution(s) of the quadratic program 1 are invariant w.r.t. shifting all elements of matrix X by a constant.

Proof:

By shifting the elements of X by λ, the objective function in Eqn. 1 is written by

$$\begin{matrix}f ( v , λ ) = {v}^{T} ( X + λ {ee}^{T} ) v . & ( 7 ) \\ Then , & \\ \begin{matrix}{v}^{T} ( X + λ {ee}^{T} ) v = {v}^{T} Xv + {v}^{T} λ {ee}^{T} v \\ = {v}^{T} Xv + λ \underbrace{( {v}^{T} e )}_{= 1} \underbrace{( {e}^{T} v )}_{= 1} \\ = {v}^{T} Xv + λ ,\end{matrix} & ( 8 )\end{matrix}$$

where e=(1, 1, . . . , 1)^{T} is a vector of 1 s. Therefore, shifting the elements of X does not change the optimal solution(s) of Eqn (1). □

Theorem 3:

There is a one-to-one correspondence between the solutions of the quadratic program of Eqn (6) and the replicator dynamics acting on X′ defined as:

X′=X−λ(ee^{T}−I) (9)

Proof:

The regularized objective function in Eqn. 6 is written:

$$\begin{matrix}{v}^{T} Xv + λ {‖ v ‖}_{2}^{2} = {v}^{T} Xv + λ {v}^{T} v \\ = {v}^{T} ( X + λ I ) v .\end{matrix} \qquad ( 10 )$$

However, the replicator dynamics Eqn (2) cannot be directly applied to matrix v^{T}(X+λI)v, as its diagonal elements are non-zero (violation of condition I). To make the diagonal elements zero, v^{T}(X+λI)v is replace by v^{T}(X+λI−λee^{T})v, i.e., all elements of v^{T}(X+λI)v are shifted by −λ (at S108). This transformation is valid, as according to Lemma 2, shifting all the elements by a constant does not change the solution of the objective function. This gives a matrix X′, defined as X′=X−λ(ee^{T}−I), on which performing the replicator dynamics gives the solutions of the regularized objective function in Eqn (6). □

Optimal Regularization:

Choosing a large λ may be advantageous as it renders a tighter distribution on v, i.e., a quicker appearance of a phase transition. However, there is an upper limit on the value of λ. Theorem 4 determines such a upper bound on λ.

Theorem 4

The largest λ that can be used to accelerate the appearance of phase transition is the minimum of the non-diagonal elements of X.

Proof:

Adding −λ(ee^{T}−I) to X implies shifting the non-diagonal elements of X by −λ. According to condition II, the non-diagonal elements must be non-negative. Thus, there is a limit on the negative shift of non-diagonal elements. i.e., the largest negative shift is the minimum of non-diagonal elements. □

Therefore, inside the run_replic dynamics(X,T) function, the first step is to subtract from the non-diagonal elements of X the minimum value and then perform the replicator dynamics for T update steps using X′. Using this adaptive replicator dynamics, for the toy dataset of FIG. 13, the maximal phase transition and its convergence are obtained after only one update step, i.e., for T=1, which is significantly smaller than T=40 for the unregularized version (FIG. 16).

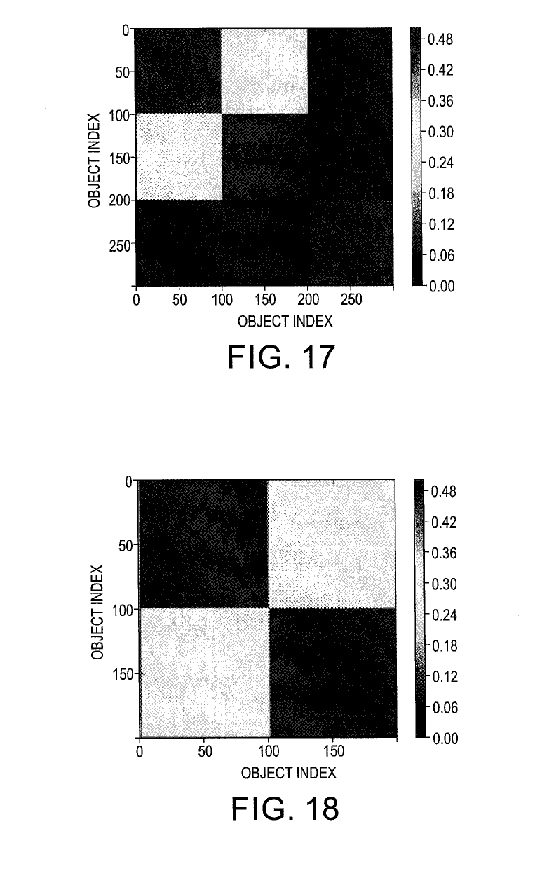

In the running example (the dataset depicted in FIG. 3), after performing the first cut, i.e., separating the cluster at the top, the second half of the dataset contains the two lower clusters. The matrixes of pairwise similarities for the whole data and for the second half of the data are depicted in FIGS. 17 and 18, respectively. The similarity matrix of the second half shows two nested clusters, although the inter-cluster similarities are non-zero. The non-zero inter-cluster similarities render the convergence of replicator dynamics slow. The regularized objective function of Eqn (6) makes the inter-cluster similarities zero, and thus accelerates the convergence and also the occurrence of phase transition. Using adaptive replicator dynamics clustering, a smaller T is needed, e.g., T=15 instead of T=40 when using RDC without the regularization. As noted above, for the standard Dominant Set Clustering method, at least T=130 iterations are needed.

The output of the method (S120) may be the clustering solution c in which each cᵢ indicates the cluster label for object i (one of the labels may correspond to “no label”, which is assigned to the objects removed by pruning). Alternatively, the system may process the data based on the assignments and output information based thereon. For example, information may be extracted from the objects in a cluster.

The analysis of trajectory of replicator dynamics while running reveals the appearance of informative phase transitions that correspond to the cuts over data. This observation is exploited to design an efficient clustering method implemented in two steps: i) Cut Identification, and ii) Cluster Pruning. In order to accelerate the occurrence of phase transitions, regularization of the corresponding objective function can be used, which includes subtracting, from the non-diagonal elements of similarity matrix, the minimum of all non-diagonal elements. The experiments on synthetic and real-world datasets show the effectiveness of the algorithm compared to the alternative methods.

Without intending to limit the scope of the exemplary embodiment, the follow examples demonstrate the application of the exemplary RDC clustering method and comparisons with other clustering methods.

### Examples

The effectiveness of the exemplary RDC algorithm on a variety of synthetic and real-world datasets is evaluated and the results compared against other clustering methods.

1. Experiments with Synthetic Data

First, different aspects of RDC, as compared to the alternative methods, are studied:

Sensitivity to Outliers.

It is known that spectral methods (e.g. SC, PIC and PSC) are sensitive to the presence of outliers (Ali Rahimi, et al., “Clustering with normalized cuts is clustering with a hyperplane,” Statistical Learning in Computer Vision (2004); and Boaz Nadler, et al., “Fundamental limitations of spectral clustering methods,” Advances in Neural Information Processing Systems 19, pp. 1017-1024 (2007), hereinafter, Nadler 2007). For example, spectral methods are not able to separate the signal from the noise for the data depicted in FIG. 3. RDC does this separation because of its inherent property which aims at capturing the well-connected regions of data.

Clusters with Arbitrary Shapes.

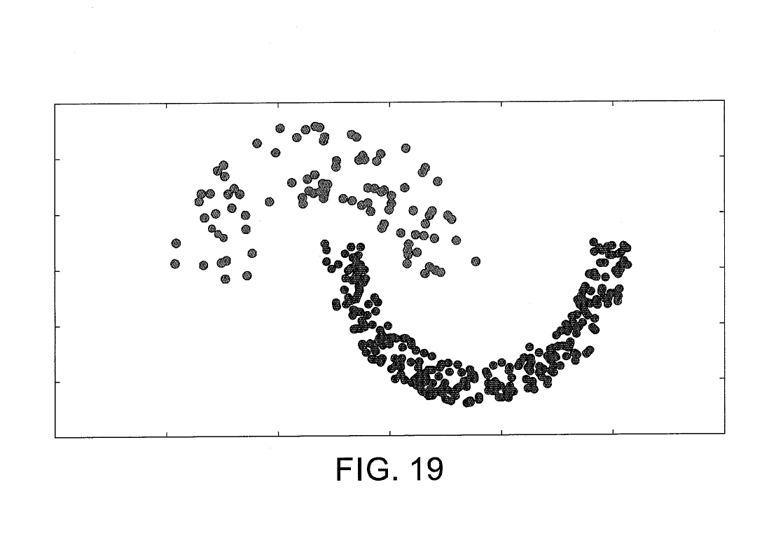

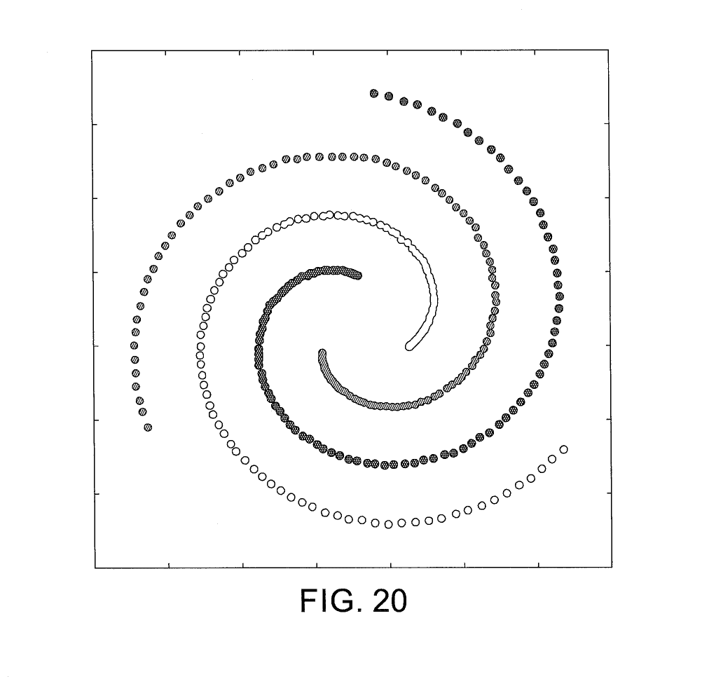

An advantage of spectral methods for clustering is supposed to be the ability to cope with the arbitrary shape of clusters. However, this ability depends very much on the particular choice of pairwise similarities, particularly on the choice of a when Xᵢⱼ=expâᵢ (−Dᵢⱼ/σ) (Nadler 2007, Ulrike von Luxburg, “A tutorial on spectral clustering,” Statistics and Computing, 17(4):395-416 (2007)) such that finding an appropriate value for σ is not trivial and requires prior knowledge about the shape and the type of clusters, which is not practical in many applications. An effective approach to extract clusters with arbitrary shapes is to use a path-based distance measure (Bernd Fischer, et al., “Pathbased clustering for grouping of smooth curves and texture segmentation,” IEEE Trans. Pattern Anal. Mach. Intell., 25(4):513-518 (2003)), which computes the minimum largest gap among all admissible paths between the pairs of objects. Combining the RDC method with this distance measure can be advantageous: the path-based measure essentially computes the transitive (indirect) relations, i.e., maps a cluster with an arbitrary shape to a well-connected sub-graph. The exemplary algorithms provide an efficient way to extract significant well-connected groups. FIGS. 19 and 20 illustrate the results on two circular datasets. The path-based distances D^{path} are obtained from the pairwise squared Euclidean distances D. Then, X is computed by X=max(D^{path})−D^{path}+min(D^{path}) and RDC is applied. Thus no parameter needs to be fixed in advance to compute the pairwise similarities correctly.

RDC Vs. PIC.

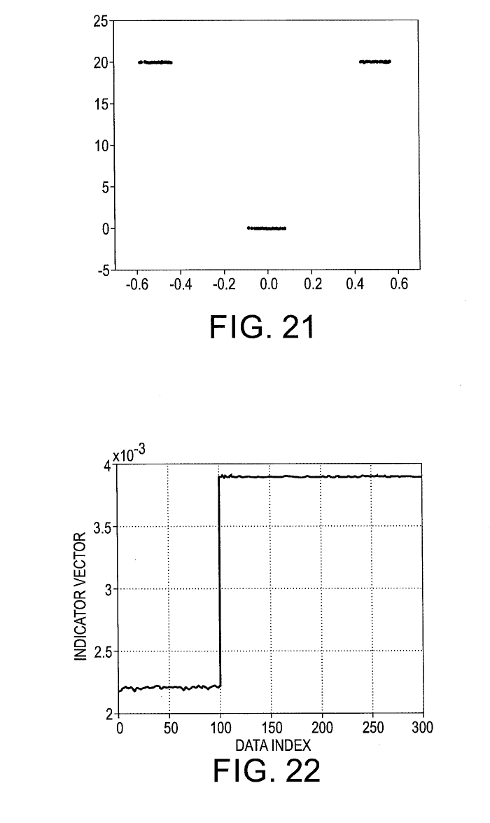

Both RDC and PIC perform based on an equation, e.g., power iteration (PIC) or replicator dynamics (RDC), which updates an initial vector iteratively, which quickly converges locally within the clusters and then converges globally either to a fixed vector representing the largest eigenvector (PIC) or to the mode of graph (RDC). Therefore, early stopping the procedure helps identification of clusters. However, a fundamental difference is that RDC performs multiple replicator dynamics sequentially, while PIC runs power iteration only once, thereby yields one clustering indicator vector. As shown in FIGS. 21 and 22, providing only one indicator vector is often not enough to capture all structures.

FIG. 21 shows an example dataset containing three well-separated clusters, where the first cluster (indices: 1-100) is far from the two others (indices: 101-300). For such cases, PIC is not able to discriminate the low level structures as shown in FIG. 22. The cluster indicator vector is almost the same for the second and third clusters. This observation is consistent with the behavior of power iteration which essentially approximates only a one-dimensional embedding for the data. RDC overcomes this issue by detecting the phase transitions of the characteristic vector and repeating replicator dynamics for each subset. Such an analysis can also be applied to PIC to improve the results. However, replicator dynamics has advantages over power iteration: i) it efficiently extracts the significant subsets and separates signal from the noise, ii) there is a direct interpretation of the replicator dynamics in terms of an objective function whose regularization to represent different resolutions can be integrated into the similarity matrix, allowing replicator dynamics to be still usable, and iii) the number of update steps, i.e. T, is not very critical for replicator dynamics as it is for power iteration. By choosing a large T, power iteration may lose the phase transition as it ultimately converges to a constant vector. However, replicator dynamics converges to the mode of graph, thereby an unnecessary large T will still indicate a phase transition.

### 2. Real-World Experiments

The performance of clustering methods on real-world datasets from different domains is studied.

Datasets:

Several clustering methods are compared on six real-world datasets. The first three datasets are selected from the 20 newsgroups text collection (Thomas M. Mitchell, “Machine Learning,” McGraw-Hill, Inc., New York, N.Y., USA, 1st edition (1997)):
i) 20ngA: ‘misc.forsale’, ‘soc.religion.christian’ and ‘talk.politics.guns’.
ii) 20ngB: ‘misc.forsale’, ‘soc.religion.christian’, and ‘rec.sport.baseball’.
iii) 20ngC: ‘rec.motorcycles’, ‘sci.space’, ‘talk.politics.misc’ and ‘misc.forsale’.

Two datasets come from MNIST digit datasets (Yann LeCun, et al., “Gradient-based learning applied to document recognition,”. Proc. IEEE, vol. 86, pp. 2278-2324 (1998)):
iv) MnstA: contains 3, 5 and 7 digit images.
v) MnstB: contains 2, 4, 6 and 8 digit images.

The last dataset is selected from Yeast dataset of UCI repository:
vi) Yeast: contains ‘CYT’, ‘NUC’, ‘MIT’ and ‘ME3’. For each dataset, the pairwise cosine similarities between the vectors are computed to obtain X.

Alternative Methods:

RDC is compared with four other clustering methods: i) Spectral Clustering (SC), ii) Power Iteration Clustering (PIC), iii) P-Spectral Clustering (PSC), and iv) Dominant Set Clustering (DSC).

Evaluation Criteria:

The true labels of the datasets, i.e., the ground truth, are available. Thus, the quality of the clusters can be evaluated by comparing against the ground truth. Three quality measures are computed: i) adjusted Rand score (Pavan 2007), which computes the similarity between the predicted and the true clusterings; ii) adjusted Mutual Information, which measures the mutual information between two partitionings (Nguyen Xuan Vinh, et al., “Information theoretic measures for clusterings comparison: Variants, properties, normalization and correction for chance,” J. Mach. Learn. Res., 11:2837-2854 (2010)); and iii) V-measure, which computes the harmonic mean of homogeneity and completeness (Andrew Rosenberg, et al., “Vmeasure: A conditional entropy-based external cluster evaluation measure,” EMNLP-CoNLL, pp. 410-420 ACL (2007)). The adjusted versions of these criteria are computed, such that they yield zero for random partitionings.

Results:

In Tables 1, 2 and 3, the results of different methods are compared with respect to the adjusted Rand score, adjusted Mutual Information and V-measure, respectively. Any positive value indicates a (partially) correct clustering. The experiments were performed under identical computational settings and conditions using an Intel machine with core i7-4600U and 2.7 GHz CPU and with 8.00 GB internal memory.

TABLE 1
Performance w.r.t. adjusted Rand score

| dataset | SC | PIC | PSC | DSC | RDC |
|---|---|---|---|---|---|
| 20ngA | 0.2803 | 0.4262 | 0.2994 | 0.3931 | 0.3905 |
| 20ngB | 0.1966 | 0.2557 | 0.1277 | 0.2379 | 0.2613 |
| 20ngC | 0.248 | 0.1753 | 0.1602 | 0.2175 | 0.2788 |
| MnstA | 0.394 | 0.5019 | 0.3763 | 0.4487 | 0.4879 |
| MnstB | 0.6525 | 0.3918 | 0.3431 | 0.6312 | 0.6169 |
| Yeast | 0.5418 | 0.4863 | 0.4149 | 0.5775 | 0.652 |

TABLE 2
Performance w.r.t. adjusted Mutual Information

| dataset | SC | PIC | PSC | DSC | RDC |
|---|---|---|---|---|---|
| 20ngA | 0.3041 | 0.349 | 0.1789 | 0.3516 | 0.3632 |
| 20ngB | 0.2586 | 0.242 | 0.1608 | 0.2517 | 0.2604 |
| 20ngC | 0.2688 | 0.1786 | 0.2079 | 0.2887 | 0.315 |
| MnstA | 0.3905 | 0.5147 | 0.4033 | 0.4606 | 0.4903 |
| MnstB | 0.5875 | 0.3075 | 0.3249 | 0.5572 | 0.5629 |
| Yeast | 0.5214 | 0.5357 | 0.4839 | 0.5637 | 0.6302 |

TABLE 3
Performance w.r.t. V-measure

| dataset | SC | PIC | PSC | DSC | RDC |
|---|---|---|---|---|---|
| 20ngA | 0.3050 | 0.4342 | 0.2234 | 0.3818 | 0.3744 |
| 20ngB | 0.2630 | 0.2719 | 0.192 | 0.2631 | 0.2807 |
| 20ngC | 0.3005 | 0.2107 | 0.2469 | 0.3366 | 0.3268 |
| MnstA | 0.4087 | 0.4835 | 0.3202 | 0.4316 | 0.4952 |
| MnstB | 0.5948 | 0.3344 | 0.3655 | 0.5704 | 0.6019 |
| Yeast | 0.5922 | 0.5796 | 0.4652 | 0.6271 | 0.6638 |

According to the results, RDC often performs equally well or better than the other methods for different evaluation criteria and, on average, performs better than the other methods. It can be observed that PIC works well when there are few clusters in the dataset (20ngA and MnstA have only three clusters), but it may fail when there are many clusters. As shown, PIC is not appropriate for capturing structures represented at different resolutions, which is a property of datasets with many clusters (e.g. 20ngB and 20ngC). PSC is a clustering method which works based on a non-linear generalization of the Laplacian matrix. However the method provides less satisfying results compared to the alternatives, as well as being computationally expensive. For example, for 20ngC, PSC is almost 50 times slower than the other methods. For this dataset, the running times of different methods are (in seconds): 1.3381 (SC), 0.8716 (PIC), 61.9709 (PSC), 1.8792 (DSC), and 1.1236 (RDC).

The disclosures of all references mentioned herein are hereby incorporated by reference herein in their entireties, by reference.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for data clustering comprising:
for a dataset of objects partitioned into a current set comprising two clusters, with a processor, iteratively increasing a number of the clusters in the current set of clusters comprising:
performing replicator dynamics on the objects in each of the two clusters for a predetermined number of iterations to solve an objective function;
for each of the two clusters, computing a cut-off based on a characteristic vector of the solved objective function; and
selecting one of the clusters in the current set of clusters which provides most gain to the objective function when that cluster is split into two new clusters at the respective cut-off;
splitting the selected one of the two clusters into two new clusters based on the cut-off and adding the two new clusters to the current set of clusters;
wherein in a next iteration, the replicator dynamics is performed on the two new clusters.

2. The method of claim 1, wherein the iterative increasing of the number of the clusters is performed until a predefined number of clusters is reached.

3. The method of claim 1, wherein each index i of the characteristic vector corresponds to one of the objects in the respective cluster.

4. The method of claim 1, wherein the replicator dynamics maximizes a function of the characteristic vector and a similarity matrix.

5. The method of claim 4, wherein the similarity matrix is a matrix based on pairwise similarities for the objects in the respective cluster on which replicator dynamics is performed.

6. The method of claim 4, wherein the replicator dynamics maximizes one of the functions:
$$\begin{matrix}f ( v ) = {v}^{T} Xv , \\ and & ( 1 ) \\ {f}^{reg} ( v , λ ) = {v}^{T} {X}^{′} v + λ {‖ v ‖}_{2}^{2} . & ( 6 ) \\ subject to v \geq 0 , {\sum }_{i = 1}^{N} {v}_{i} = 1 , & \end{matrix}$$
where v is the characteristic vector, N is the number of indices i in v, each index having a value νᵢ, X represents a pairwise similarity matrix, X′, represents a similarity matrix derived from X, and λ is a regularization parameter.

7. The method of claim 6, wherein in X′, pairwise similarities in the similarity matrix X are offset by λ.

8. The method of claim 6, wherein λ has a value which is no greater than a minimum of the non-diagonal elements of X.

9. The method of claim 1, wherein the gain is computed according to:
gₖ=ƒ(v(T))−ƒ(v(t₀)). (4)
where ƒ(v(T)) represents the value of the objective function after T iterations of replicator dynamics, v is the characteristic vector, and ƒ(v(t₀)) represents a uniform distribution.

10. The method of claim 1, wherein the cut-off corresponds to a sharpest transition between values of sequential indices in the characteristic vector.

11. The method of claim 1, wherein the computing of the cut-off comprises:
identifying the minimum and maximum values in the characteristic vector;
partitioning the interval between the minimum and maximum values into a set of N−1 equal sized blocks, N being the number of indices in the characteristic vector;
assigning the objects in the cluster on which replicator dynamics has been performed to the blocks based on the value of the corresponding index in the characteristic vector;
for each block, identifying the maximum and minimum values in the block;
constructing an ordered list by concatenating the minimum and the maximum values of each the blocks and arranging them in order, the list beginning with the minimum value and ending with the maximum value;
computing a difference between each consecutive pair in the ordered list to obtain a position of a maximal transition; and
identifying the cut-off based on the position of the maximal transition.

12. The method of claim 1, wherein in the replicator dynamics, Equation 2 is repeated for a fixed number T of iterations:
$${v}_{i} ( t + 1 ) = {v}_{i} ( t ) \frac{{( Xv ( t ) )}_{i}}{{v ( t )}^{T} Xv ( t )} , i = 1 , … , N , t = 1 , … , T , \qquad ( 2 )$$
where t represents a first iteration and t+1 represents a next iteration after t, N represents the number of objects i in the cluster on which replicator dynamics is performed, represents a similarity matrix based on similarity between the objects in the cluster, and ν₁ represents the respective value of the object i in the characteristic vector v.

13. The method of claim 1, further comprising pruning the clusters, the pruning comprising:
for each of the clusters,
performing replicator dynamics on the objects in the cluster for a predetermined number of iterations to solve the objective function,
computing a cut-off based on a characteristic vector of the solved objective function; and
removing the objects below the cut-off from the cluster.

14. The method of claim 1, further comprising generating the dataset of objects from a single cluster, comprising:
performing replicator dynamics on the objects in the single cluster for a predetermined number of iterations to solve the objective function;
computing a cut-off based on a characteristic vector of the solved objective function; and
splitting the single clusters into two clusters based on the cut-off.

15. The method of claim 1, wherein the performing of replicator dynamics on the objects in each of the two new clusters is performed for a predetermined number of iterations which is less than a number of iterations for convergence.

16. A computer program product comprising a non-transitory recording medium storing instructions, which when executed on a computer, causes the computer to perform the method of claim 1.

17. A system comprising memory which stores instructions for performing the method of claim 1 and a processor in communication with the memory for executing the instructions.

18. A system for clustering objects comprising:
a similarity matrix computation component which computes pairwise similarities for a dataset of objects and for clusters generated from the dataset and which generates a pairwise similarity matrix based on the pairwise similarities;
a replicator dynamics component which performs replicator dynamics on the dataset of objects and on clusters generated from the dataset, to solve an objective function which is a function of the pairwise similarity matrix;
a cut-off computation component which computes a cut-off based on a characteristic vector of the solved objective function;
a gain computation component which computes a gain in the objective function when each of the clusters is split into two new clusters at the computed cut-off for that cluster and which identifies a cluster to be split which provides most gain to an objective function when that cluster is split into the two new clusters;
a pruning component which prunes the clusters when a desired number of clusters is reached; and
a processor which implements the similarity matrix computation component, replicator dynamics component, cut-off computation component, gain computation component, and pruning component to iteratively increase the number of the clusters.

19. The system of claim 18, further comprising a regularization parameter computation component which computes a regularization parameter for the objective function based on the pairwise similarities.

20. A method for data clustering comprising:
partitioning a dataset of objects into clusters, the partitioning including, with a processor:
a) performing replicator dynamics on the objects the dataset of objects for a predetermined number of iterations to solve an objective function;
b) computing a cut-off based on a characteristic vector of the solved objective function; and
c) splitting the dataset into two clusters based on the cut-off to form a current set of clusters;
d) computing a gain achieved by splitting each of the clusters in the current set of clusters into two new clusters when a), b), and c) are performed for each of the clusters;
e) partitioning the cluster with the maximum gain into two new clusters and adding the two new clusters to the current set of clusters; and
f) repeating d) and e) for a number of iterations until a predetermined number of clusters is reached.
